(19) United States
(12) Patent Application Publication
(10) Pub. No.: US 2024/0425408 A1
(43) Pub. Date: Dec. 26, 2024

(54) METHOD AND APPARATUS FOR MANUFACTURING GLASS ARTICLES WITH REDUCED ELECTROSTATIC ATTRACTION

(71) Applicant: CORNING INCORPORATED, CORNING, NY (US)

(72) Inventors: James William Brown, The Villages, FL (US); William John Bub, III, Ontario, NY (US); Joseph James McIntosh, Painted Post, NY (US); Jonathan Michael Mis, Horseheads, NY (US); William Paul Ryszytiwskyj, Conesus, NY (US); Dean George Sakona, Corning, NY (US); Dean Michael Thelen, Addison, NY (US); Wanda Janina Walczak, Big Flats, NY (US)

(21) Appl. No.: 18/684,376

(22) PCT Filed: Aug. 30, 2022
(86) PCT No.: PCT/US2022/041977

§ 371 Date: Feb. 16, 2024

Related U.S. Application Data
(60) Provisional application No. 63/243,429, filed on Sep. 13, 2021.

(51) Int. Cl. C03C 21/00; C03C 23/00

(52) U.S. Cl. CPC C03C 21/00; C03C 23/006

(57) ABSTRACT

A method and apparatus for manufacturing a glass article includes flowing a glass ribbon through a housing having first and second side walls. The glass ribbon has first and second opposing major surfaces extending in a lengthwise and a widthwise direction. Ions are directed from an ionization source toward at least one of the first and second opposing major surfaces of the glass ribbon and/or an electrode directs particles away from at least one of the first and second opposing major surfaces of the glass ribbon. Such can reduce a density of particles on a major surface of the glass article formed from the glass ribbon.

### CROSS-REFERENCE TO RELATED APPLICATIONS

This application claims the benefit of priority under 35 U.S.C. § 119 of U.S. Provisional Application Ser. No. 63/243,429, filed on Sep. 13, 2021, the content of which is relied upon and incorporated herein by reference in its entirety.

### FIELD

The present disclosure relates generally to methods and apparatuses for manufacturing glass articles and more particularly to methods and apparatuses for manufacturing glass articles with reduced electrostatic attraction.

### BACKGROUND

In the production of glass articles, such as glass sheets for display applications, including televisions and hand-held devices, such as telephones and tablets, the glass articles can be produced from a ribbon of glass that continuously flows through a housing. During this process, particles, such as dust or small glass fragments, may adhere to the glass ribbon, resulting in undesirable surface particles on the resulting glass article. Such particle adherence can occur as the result of electrostatic attraction between the particles and the ribbon. Accordingly, it would be desirable to mitigate such particle adherence.

### SUMMARY

Embodiments disclosed herein include an apparatus for manufacturing a glass article. The apparatus includes a housing that includes a first side wall and a second side wall, the housing forming an enclosure for an atmosphere and a glass ribbon. The glass ribbon has first and second opposing major surfaces extending in a lengthwise and a widthwise direction and the housing has first and second side walls configured to extend along at least a portion of the first and second opposing major surfaces in the lengthwise and widthwise directions. The apparatus also includes an ionization source configured to direct ions within the housing and toward at least one of the first and second opposing major surfaces of the glass ribbon and/or an electrode configured to direct particles away from at least one of the first and second opposing major surfaces of the glass ribbon. The apparatus is configured to manufacture the glass article wherein a density of particles having a diameter of less than about 212 microns on a major surface of the glass article is less than about 0.008per square centimeter.

Embodiments disclosed herein also include a method for manufacturing a glass article. The method includes flowing a glass ribbon having first and second opposing major surfaces extending in a lengthwise and a widthwise direction in an atmosphere through a housing. The housing includes a first side wall and a second side wall, the first and second side walls extending along at least a portion of the first and second opposing major surfaces in the lengthwise and widthwise directions. The method also includes, within the housing, directing ions from an ionization source toward at least one of the first and second opposing major surfaces of the glass ribbon and/or using an electrode to direct particles away from at least one of the first and second opposing major surfaces of the glass ribbon. In addition, the method includes forming the glass article from at least a portion of the glass ribbon, wherein a density of particles having a diameter of less than about 212 microns on a major surface of the glass article is less than about 0.008 per square centimeter.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of an example fusion down draw glass-making apparatus and process;

FIG. 2 is a side schematic perspective view of an example glass manufacturing apparatus and process including an ionization source configured to direct ions within a housing in accordance with embodiments disclosed herein;

FIG. 3 is a side schematic perspective view of an example glass manufacturing apparatus including a glass separation apparatus and process and further including a ionization source configured to direct ions in the vicinity of the glass separation apparatus in accordance with embodiments disclosed herein;

FIG. 4 is a cutaway side schematic perspective view of glass ribbon processing using an example ionization source and enhancer in accordance with embodiments disclosed herein;

FIG. 5 is a cutaway side schematic perspective view of glass ribbon processing using an example ionization source and enhancer in accordance with embodiments disclosed herein;

FIG. 6 is a cutaway side schematic perspective view of glass ribbon processing using an example ionization source in accordance with embodiments disclosed herein;

FIG. 7 is a cutaway perspective view of glass ribbon processing using an example ionization source in accordance with embodiments disclosed herein;

FIGS. 8A and 8B are perspective views of an example glass manufacturing apparatus and process including electrodes in accordance with embodiments disclosed herein; and

FIGS. 9A and 9B are perspective views of an example glass manufacturing apparatus and process including electrodes in accordance with embodiments disclosed herein.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “cooling mechanism” refers to a mechanism that provides increased heat transfer from an area relative to a condition where such cooling mechanism is absent. The increased heat transfer can occur through at least one of conduction, convection, and radiation.

As used herein, the term “housing” refers to an enclosure in which a glass ribbon is formed, wherein as the glass ribbon travels through the housing, it generally cools from a relatively higher to relatively lower temperature. While embodiments disclosed herein have been described with reference to a fusion down draw process, wherein a glass ribbon flows down through a housing in a generally vertical direction, such embodiments are also applicable to other glass forming processes, such as float processes, slot draw processes, up-draw processes, and press-rolling processes, wherein the glass ribbon may flow through the housing in a variety of directions, such as a generally vertical direction or a generally horizontal direction.

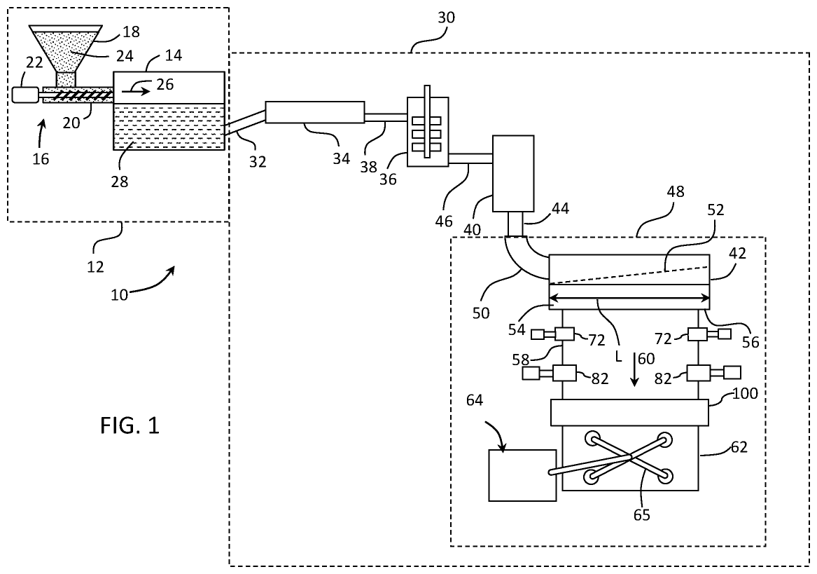

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. However, other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. While mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass-making apparatus can comprise a trough 52 positioned in an upper surface of the forming body 42 and converging forming surfaces 54 that converge in a draw direction along a bottom edge 56 of the forming body 42. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

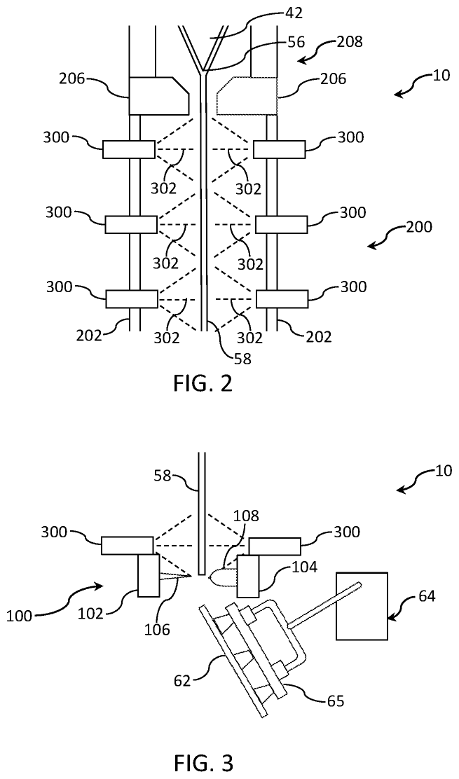

FIG. 2 shows a schematic perspective view of an example glass manufacturing apparatus 10 and process including an ionization source 300 configured to direct ions 302 within a housing 200 in accordance with embodiments disclosed herein. Specifically, in the embodiment shown in FIG. 2, glass ribbon 58 flows lengthwise below bottom edge 56 of forming body 42 and between first and second side walls 202 of housing 200. Housing 200 can be generally separated from forming body enclosure 208 by separation members 206, wherein, with reference to draw or flow direction 60 of glass ribbon 58, housing 200 is downstream relative to forming body enclosure 208. In addition, FIG. 2 shows a plurality of ionization sources 300, each of which directs ions 302 between first and second sidewalls 202 of housing 200 and toward first and second opposing major surfaces of glass ribbon 58. In particular, a first subset of the plurality of ionization sources 300 directs ions 302 along a lengthwise direction of a first major surface of glass ribbon 58 and a second subset of the plurality of ionization sources 300 directs ions 302 along a lengthwise direction of a second major surface of glass ribbon 58.

FIG. 3 shows a side schematic perspective view of an example glass manufacturing apparatus 10 including a glass separation apparatus 100 and process and further including a ionization source 300 configured to directions 302 in the vicinity of the glass separation apparatus 100 in accordance with embodiments disclosed herein. Glass separation apparatus 100 includes a first portion 102 extending along a first major surface of glass ribbon 58 and a second portion 104 extending along an opposing second major surface of glass ribbon 58. First portion 102 of separation apparatus 100 includes a scoring apparatus 106 (e.g., a score wheel, etc.) and second portion 104 of separation apparatus 100 includes a nosing 108. During the separation process, scoring apparatus 106 can impart a score line along first major surface of glass ribbon 58 and bending against nosing 108 can facilitate separating an individual glass sheet 62 from the glass ribbon 58. Then, as noted above, robot 64 may then transfer the individual glass sheets 62 using gripping tool 65. As further shown in FIG. 3, each of first and second portions 102, 104 of separation apparatus 100 include an ionization source 300 that directs ions 302 toward first and second opposing major surfaces of glass ribbon 58.

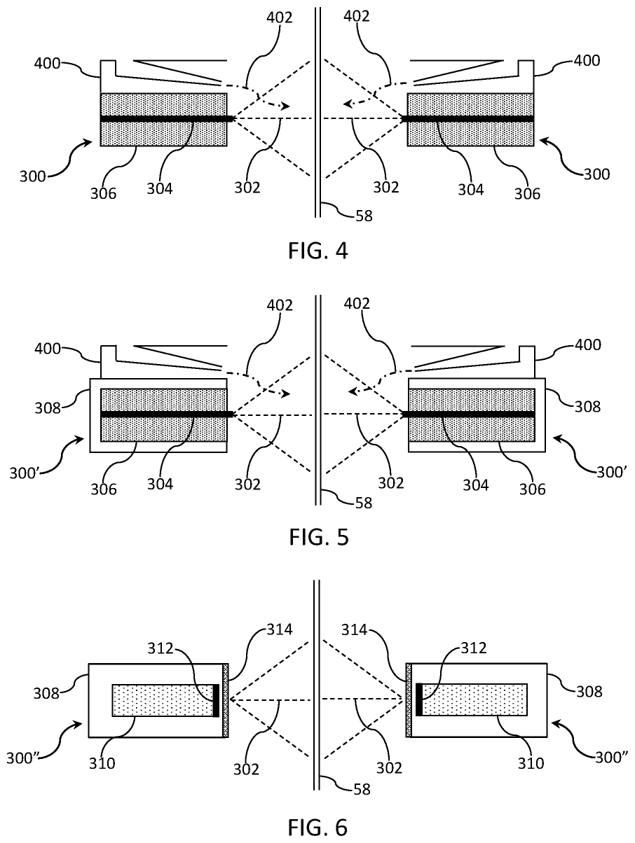

In certain exemplary embodiments, ionization source 300 can comprise a corona discharge ionizer, soft X-ray ionizer, or nuclear ionizer, as known to persons having ordinary skill in the art. FIG. 4 shows a cutaway side schematic perspective view of glass ribbon 58 processing using an example ionization source 300 and enhancer 400 in accordance with embodiments disclosed herein. Specifically, FIG. 4 shows two ionization sources 300 each directing ions 302 on first and second major surfaces of glass ribbon 58. Ionization source 300 of FIG. 4 comprises a corona discharge ionizer including a conductive emitter 304 housed in a thermally insulative material 306. Conductive emitter 304 directs ions 302 towards major surfaces of glass ribbon 58. Thermally insulative material 306 may, for example, comprise a ceramic conduit that circumferentially surrounds conductive emitter 304. Ceramic conduit may, for example, comprise a thermally and electrically insulative ceramic material such as boron nitride, silica, silicon nitride, alumina, aluminum silicate, aluminum nitride, or MACOR® machinable glass ceramic.

As shown in FIG. 4, enhancer 400 is positioned above ionization source 300 and is configured to flow a fluid 402, such as a gaseous fluid, toward a major surface of glass ribbon 58. Specifically, enhancer 400 acts in concert with ionization source 300 to increase a flow velocity of ions 302 toward a major surface (i.e., at least one of the first and second opposing major surfaces) of the glass ribbon 58. And while enhancer 400 is shown as being positioned directly above ionization source 300, embodiments disclosed herein include those in which enhancer 400 is positioned elsewhere, such as below and/or to the side of ionization source 300.

In certain exemplary embodiments, enhancer 400 may comprise an air knife, such as an air knife used in the glass processing industry as known to persons having ordinary skill in the art.

FIG. 5 shows a cutaway side schematic perspective view of glass ribbon 58 processing using an example ionization source 300′ and enhancer 400 in accordance with embodiments disclosed herein. Specifically, FIG. 5 shows two ionization sources 300′ each directing ions 302 on first and second major surfaces of glass ribbon 58. Ionization source 300′ of FIG. 5 is similar to that shown in FIG. 4 except ionization source 300′ further comprises a heat shielding and cooling housing 308 that circumferentially surrounds thermally insulative material 306. Heat shielding and cooling housing 308 can comprise a cooling mechanism wherein a cooling fluid (not shown) is flowed therethrough. The cooling fluid may comprise a gas, such as air, and/or a liquid, such as water.

FIG. 6 shows a cutaway side schematic perspective view of glass ribbon 58 processing using an example ionization source 300″ in accordance with embodiments disclosed herein. Specifically, FIG. 6 shows two ionization sources 300″ each directing ions 302 on first and second major surfaces of glass ribbon 58. Ionization source 300″ of FIG. 6 comprises a soft X-ray ionizer including soft X-ray photoionizer 310, soft X-ray photo eye 312, and high temperature radio-luminescent cover 3 14 as known to persons having ordinary skill in the art. Ionization source 300″ further comprises a heat shielding and cooling housing 308 that circumferentially surrounds the soft X-ray photoionizer 310 and soft X-ray photo eye 312. Heat shielding and cooling housing 308 can comprise a cooling mechanism wherein a cooling fluid (not shown) is flowed therethrough. The cooling fluid may comprise a gas, such as air, and/or a liquid, such as water.

Insulative material 306 and/or heat shielding and cooling housing 308 can facilitate operation of ionization source 300, 300′, 300″ in high temperature environments, such as temperatures of at least about 200° C., such as at least about 250° C., and further such as at least about 300° C., and yet further such as at least about 350° C., and still yet further such as at least about 400° C., including from about 200° C. to about 500° C.

Accordingly, embodiments disclosed herein include those in which ions 302 are directed toward at least one of the first and second opposing major surfaces of glass ribbon 58 in an atmosphere within housing 200 having a temperature of at least about 200° C., such as at least about 250° C., and further such as at least about 300° C., and yet further such as at least about 350° C., and still yet further such as at least about 400° C., including from about 200° C. to about 500° C.

Embodiments disclosed herein may comprise ionizers that use an alternating current (AC) or direct current (DC) power source to generate the voltage required for ionization as known to persons having ordinary skill in the art. In addition, embodiments disclosed herein may, for example, comprise commercially available ionizers such as the L12645, L9873, or L14471 soft X-ray photo ionizers available from Hamamatsu, Gen4 Super Ion Air Knife, Gen4 Standard Ion Air Knife, Gen4 Ionizing Bar, Gen4 Ion Air Cannon, or Gen4 Ionizing Point corona discharge ionizers available from Exair, or Linear Alpha Ionizer, Mini Ionizer, or Ion Air Source nuclear ionizers available from NRD.

Soft X-ray ionizers may, for example, be operated at a power ranging from about 7 Watts (W) to about 240 Watts (W), an input AC voltage ranging from about 24 volts (V) to about 264 volts (V) (or an input DC voltage ranging from about 12 volts (V) to about 30 volts (V)), a tube voltage ranging from about 4.98 kilovolts (kV) to about 15 kilovolts (kV), and a beam angle ranging from about 130° to about 150°. Corona discharge ionizers may, for example, be operated at a power ranging from about 1 Watt (W) to about 150 Watts (W), an input AC voltage ranging from about 24 volts (V) to about 264 volts (V) (or an input DC voltage ranging from about 5 volts (V) to about 30 volts (V)), an output voltage ranging from about 0 kilovolts (kV) to about 60 kilovolts (kV), an a balance ranging from about ±50 volts (V).

In certain exemplary embodiments, a closest distance between ionization source 300, 300′, 300″ and glass ribbon 58 may, for example, range from about 10 millimeters to about 3,000 millimeters, such as from about 50 millimeters to about 1,000 millimeters, and further such as from about 100 millimeters to about 500 millimeters.

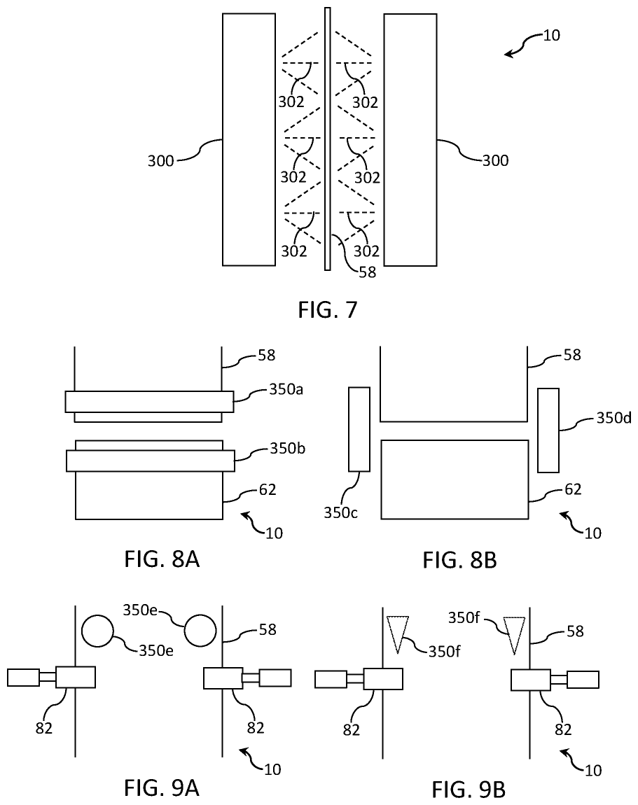

Embodiments disclosed herein may, for example, include ionization sources 300, 300′, 300″ that extend in varying directions relative to glass ribbon 58, such as along a widthwise direction of glass ribbon 58 or a lengthwise direction of glass ribbon 58. FIG. 7 shows a cutaway perspective view of glass ribbon 58 processing using an example ionization source 300 in accordance with embodiments disclosed herein. Specifically, FIG. 7 shows two ionization sources 300 each directing ions 302 on first and second major surfaces of glass ribbon 58. Ionization sources 300 may extend along a widthwise direction of glass ribbon 58, such as in embodiments shown in FIG. 2 or 3, and/or along a widthwise direction of a glass sheet 62. Ionization sources 300 many also extend along a lengthwise direction of glass ribbon 58 and/or or along a lengthwise direction of a glass sheet 62. For example, embodiments disclosed herein include those in which outer edge regions of a glass ribbon 58 and/or a glass sheet 62 having an area of increased thickness relative to the rest of the glass ribbon 58 and/or glass sheet 62 (known as “bead regions” to persons having ordinary skill in the art) are separated from the remainder of the glass ribbon 58 and/or glass sheet 62 wherein ionization sources 300 extend along a lengthwise direction of the glass ribbon 58 and/or glass sheet 62 proximate to an area of separation between bead regions and the remainder of glass ribbon 58 and/or glass sheet 62. In such situations, ionization sources 300 may directions 302 on first and second major surfaces of glass ribbon 58 and/or glass sheet 62.

Embodiments disclosed herein include those in which a voltage differential exists between the ions 302 directed toward glass ribbon 58 and the glass ribbon 58. Embodiments disclosed herein also include those in which a voltage differential between the ions 302 and the glass ribbon 58 is reduced as compared to a condition where ions 302 are not directed from an ionization source 300 toward at least one of the first and second opposing major surfaces of the glass ribbon 58. For example, embodiments disclosed herein include those in which a voltage differential between the ions 302 and the glass ribbon 58, is reduced by at least about 90%, such as at least about 95%, and further such as at least about 98%, including from about 90% to about 99% as compared to a condition where ions 302 are not directed from an ionization source 300 toward at least one of the first and second opposing major surfaces of the glass ribbon 58.

Given that embodiments disclosed herein include those in which glass ribbon 58 moves (e.g., in draw direction 60) relative to ionization source(s) 300, such embodiments include those in which ions 302 arrive at or near a major surface of glass ribbon 58 in sufficient time to reduce a voltage differential between a given surface area of the glass ribbon 58 and the ions 302 by a sufficient amount (e.g., at least about 90%) before the given surface area of the glass ribbon 58 has moved a predetermined distance relative to the ionization source(s) 300. Accordingly, a time in which a sufficient (e.g., at least about 90%) voltage differential reduction of the given surface area of the glass ribbon 58 is achieved can be less than about 5 seconds, such as less than about 2 seconds, and further such as less than about 1 second, such as from about 0.1 to about 5 seconds, and further such as from about 0.2to about 2 seconds.

Achieving a sufficient (e.g., at least about 90%) voltage differential reduction of the given surface area of the glass ribbon 58 in sufficient time (e.g., less than about 5 seconds) may, for example, be facilitated by use of an enhancer 400 (e.g., an air knife) in combination with an ionization source 300, 300′, 300″ in order to increase the velocity of ions 302 in the direction of the given surface area of the glass ribbon 58 (as shown, for example, in FIGS. 4 and 5). Such may also be achieved by use of an ionization source 300″ comprising a soft X-ray ionizer (as shown, for example, in FIG. 6) with or without an enhancer 400.

Achieving a voltage differential reduction between a surface area of glass ribbon 58 and ions 302 can also simultaneously achieve a voltage differential reduction between the glass ribbon 58 surface area and particles in the vicinity of the glass ribbon 58 surface area, which voltage differential reduction results from interactions between not only the ions 302 and the glass ribbon 58 surface area but also from interactions between the ions 302 and the particles. Such voltage differential reduction can, in turn, reduce electrostatic attraction between the glass ribbon 58 surface area and the particles which can, in turn, result in reduced particle adherence on the glass ribbon 58 surface area.

FIGS. 8A and 8B show perspective views of an example glass manufacturing apparatus 10 and process including electrodes 350a, 350b, 350c, 350d in accordance with embodiments disclosed herein. Specifically, each of electrodes 350a, 350b, 350c, and 350d comprises a conductive bar. Conductive bar may, for example, comprise a generally cylindrical shape (i.e., circular cross-section). Conductive bar may also comprise other shapes (such as those having an oval or polygonal cross-section).

As shown in FIG. 8A, electrodes 350a and 350b are positioned along a widthwise direction of glass ribbon 58 and glass sheet 62, respectively, above and below a separation apparatus (not shown). Electrodes 350a and 350b may, for example, be oppositely charged by one or more voltage sources, such as by, for example, a dual output high voltage power supply, wherein one of electrodes 350a and 350b may be grounded.

As shown in FIG. 8B, electrodes 350c and 350d are positioned along a lengthwise direction of glass ribbon 58 and glass sheet 62, respectively, above and below a separation apparatus (not shown). Electrodes 350c and 350d may, for example, be oppositely charged by one or more voltage sources, such as by, for example, a dual output high voltage power supply, wherein one of electrodes 350c and 350d may be grounded.

FIGS. 9A and 9B show perspective views of an example glass manufacturing apparatus 10 and process including electrodes 350e, 350f in accordance with embodiments disclosed herein. Electrodes 350e of FIG. 9A comprise a conductive sphere. Electrodes 350f of FIG. 9B comprise a conductive polygon (and while electrodes 350f are shown as having a conical shape or triangular cross-section, embodiments disclosed herein may include other polygonal shapes). Electrodes 350e, 350f may, for example, be charged by one or more voltage sources, such as by, for example, a controllable output high voltage power supply.

In FIGS. 9A and 9B, electrodes 350e, 350f are shown as being positioned above pulling rolls 82. Pulling rolls 82 may impart an electrostatic charge onto glass ribbon 58. To counteract the electrostatic charge imparted onto glass ribbon 58 by pulling rolls 82, electrodes 350e, 350f may impart an opposing charge onto glass ribbon 58.

For example, in certain exemplary embodiments, pulling rolls 82 may impart a negative charge onto glass ribbon 58 and electrodes 350e, 350f may impart a positive charge onto glass ribbon 58. In other exemplary embodiments, pulling rolls 82 may impart a positive charge onto glass ribbon 58 and electrodes 350e, 350f may impart a negative charge onto glass ribbon 58. And while, in FIGS. 9A and 9B, electrodes 350e, 350f are shown as being positioned above pulling rolls 82, embodiments disclosed herein can include those in which electrodes 350e, 350f are otherwise positioned relative to pulling rolls 82, such as below or to the side of pulling rolls 82.

Electrodes 350a-f can be configured to direct particles away from at least one of the first and second opposing major surfaces of glass ribbon 58 and/or glass sheet 62. For example, in certain exemplary embodiments one or more of electrodes 350a-f may affect the charge of particles in the vicinity of glass ribbon 58 and/or glass sheet 62 so as to reduce electrostatic attraction between the particles and the glass ribbon 58 and/or glass sheet 62. In certain exemplary embodiments, one or more of electrodes 350a-f may affect the overall charge of the glass ribbon 58 and/or glass sheet 62 so as to reduce electrostatic attraction between the particles and the glass ribbon 58 and/or glass sheet 62.

In certain exemplary embodiments, one or more of electrodes 350a-f may be monitored and/or controlled by a control mechanism, such as a feedback or feedforward control mechanism as known to persons having ordinary skill in the art. In certain exemplary embodiments, the control mechanism may be in communication with a condition measuring device, such as a field meter or voltmeter that measures an electrostatic charge or potential within or between one or more areas or regions, such as within an area in the vicinity of the glass ribbon 58 and/or glass sheet 62, including within an area that includes the glass ribbon 58 and/or glass sheet 62 and one or more electrodes 350a-f. The control mechanism may then respond to one or more conditions measured by the condition measurement device to, for example, control or maintain a charge and/or voltage of electrodes 350a-f relative to glass ribbon 58 and/or glass sheet 62 so as to control or minimize electrostatic charge between glass ribbon 58 and/or glass sheet 62 and particles in the vicinity thereof.

Electrodes 350a-f may, for example, be operated at a power ranging from about 1 Watt (W) to about 150 Watts (W), an input AC voltage ranging from about 24 volts (V) to about 264 volts (V) (or an input DC voltage ranging from about 5 volts (V) to about 30 volts (V)), and an output voltage ranging from about 0 kilovolts (kV) to about 60 kilovolts (kV).

In certain exemplary embodiments, a closest distance between electrodes 350a-f and glass ribbon 58 may, for example, range from about 0 millimeters to about 2,000millimeters, such as from about 10 millimeters to about 1,000 millimeters, and further such as from about 50 millimeters to about 500 millimeters.

In certain exemplary embodiments, one or more electrodes 350a-f may comprise at least one of tungsten, silicon, stainless steel, or Inconel.

Embodiments disclosed herein can enable the manufacture of glass articles having a reduced density of particles thereon. For example, embodiments disclosed herein include those in which apparatus 10 is configured to manufacture a glass article wherein a density of particles having a diameter of less than about 212 microns, such as less than about 100 microns, and further such as less than about 10 microns, and yet further such as less than about 1 micron, and still yet further such as less than about 0.3 microns, such as from about 212 microns to about 0.3 microns, on a major surface of the glass article is less than about 0.008, such as less than about 0.004, and further such as less than about 0.002, such as from about 0.0001 to about 0.008, and further such as from about 0.001 to about 0.004 per square centimeter. Embodiments discloses herein can also include methods for making glass articles that include forming the glass article from at least a portion of glass ribbon 58 article wherein a density of particles having a diameter of less than about 212 microns, such as less than about 100 microns, and further such as less than about 10 microns, and yet further such as less than about 1 micron, and still yet further such as less than about 0.3 microns, such as from about 212 microns to about 0.3 microns, on a major surface of the glass article is less than about 0.008, such as less than about 0.004, and further such as less than about 0.002,such as from about 0.0001 to about 0.008, and further such as from about 0.001 to about 0.004 per square centimeter.

Accordingly, embodiments disclosed herein can enable the manufacture of glass articles with a reduced density of particles on one or more major surfaces thereof. Such can occur, for example, by use of electrodes to affect a voltage differential between a glass ribbon 58 and/or glass sheet 62 and particles in the vicinity thereof. Such can also occur, for example, by use of an ionization source to direct ions 302 toward at least one of the first and second opposing major surfaces of the glass ribbon 58 and/or glass sheet 62. For example, embodiments disclosed herein include those in which a voltage differential between the particles and the glass ribbon 58 and/or glass sheet 62 is reduced by at least about 90%, such as at least about 95%, and further such as at least about 98%, such as from about 90% to about 99% as compared to a condition where an electrode does not direct particles away from at least one of the first and second opposing major surfaces of the glass ribbon 58 and/or glass sheet 62 and/or ions 302 are not directed from an ionization source toward at least one of the first and second opposing major surfaces of the glass ribbon 58 and/or glass sheet 62.

While the above embodiments have been described with reference to a fusion down draw process, it is to be understood that such embodiments are also applicable to other glass forming processes, such as float processes, slot draw processes, up-draw processes, and press-rolling processes.

Such processes can be used to make glass articles, which can be used, for example, in electronic devices as well as for other applications.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. An apparatus for manufacturing a glass article comprising:
a housing comprising a first side wall and a second side wall, the housing forming an enclosure for an atmosphere and a glass ribbon having first and second opposing major surfaces extending in a lengthwise and a widthwise direction, the first and second side walls configured to extend along at least a portion of the first and second opposing major surfaces in the lengthwise and widthwise directions;
an ionization source configured to directions within the housing and toward at least one of the first and second opposing major surfaces of the glass ribbon; and/or
an electrode configured to direct particles away from at least one of the first and second opposing major surfaces of the glass ribbon,
wherein a density of particles in the glass article having a diameter of less than about 212 microns on a major surface of the glass article is less than about 0.008 per square centimeter.

2. The apparatus of claim 1, wherein a temperature of the atmosphere is at least about 200° C.

3. The apparatus of claim 1, wherein the apparatus further comprises an enhancer configured to increase a flow velocity of ions toward at least one of the first and second opposing major surfaces of the glass ribbon.

4. The apparatus of claim 3, wherein the enhancer comprises an air knife.

5. The apparatus of claim 1, wherein the ionization source comprises a corona discharge ionizer, soft X-ray ionizer, or nuclear ionizer.

6. The apparatus of claim 1, wherein the ionization source comprises a conductive emitter housed in a thermally insulative material.

7. The apparatus of claim 6, wherein the thermally insulative material comprises a ceramic conduit.

8. The apparatus of claim 1, wherein the electrode comprises a pair of oppositely charged electrodes.

9. The apparatus of claim 1, wherein the electrode comprises at least one of a conductive bar, a conductive sphere, or a conductive polygon.

10. The apparatus of claim 1, wherein the apparatus is configured to reduce a voltage differential between the particles and the glass ribbon by at least about 90% as compared to a condition where an electrode is not configured to direct particles away from at least one of the first and second opposing major surfaces of the glass ribbon and/or ions are not directed from an ionization source toward at least one of the first and second opposing major surfaces of the glass ribbon.

11. A method for manufacturing a glass article comprising:
flowing a glass ribbon having first and second opposing major surfaces extending in a lengthwise and a widthwise direction through a housing comprising a first side wall and a second side wall, the first and second side walls extending along at least a portion of the first and second opposing major surfaces in the lengthwise and widthwise directions; and
within the housing, directing ions from an ionization source toward at least one of the first and second opposing major surfaces of the glass ribbon and/or using an electrode to direct particles away from at least one of the first and second opposing major surfaces of the glass ribbon; and
forming the glass article from at least a portion of the glass ribbon; wherein a density of particles having a diameter of less than about 212 microns on a major surface of the glass article is less than about 0.008 per square centimeter.

12. The method of claim 11, wherein the housing comprises an atmosphere having a temperature of at least about 200° C.

13. The method of claim 11, wherein the method further comprises using an enhancer to increase a flow velocity of ions toward at least one of the first and second opposing major surfaces of the glass ribbon.

14. The method of claim 13, wherein the enhancer comprises an air knife.

15. The method of claim 11, wherein the ionization source comprises a corona discharge ionizer, soft X-ray ionizer, or nuclear ionizer.

16. The method of claim 11, wherein the ionization source comprises a conductive emitter housed in a thermally insulative material.

17. The method of claim 16, wherein the thermally insulative material comprises a ceramic conduit.

18. The method of claim 11, wherein the electrode comprises a pair of oppositely charged electrodes.

19. The method of claim 11, wherein the electrode comprises at least one of a conductive bar, a conductive sphere, or a conductive polygon.

20. The method of claim 11, wherein a voltage differential between the particles and the glass ribbon is reduced by at least about 90% as compared to a condition where an electrode does not direct particles away from at least one of the first and second opposing major surfaces of the glass ribbon and/or ions are not directed from an ionization source toward at least one of the first and second opposing major surfaces of the glass ribbon.

21. A glass article made by the method of claim 11.

22. An electronic device comprising the glass article of claim 21.
